(19) United States
(12) Patent Application Publication
(10) Pub. No.: US 2025/0284636 A1
(43) Pub. Date: Sep. 11, 2025

(54) MEMORY SYSTEMS, MEMORY CONTROLLERS, GARBAGE COLLECTION METHODS, AND STORAGE MEDIUMS

(71) Applicant: YANGTZE MEMORY TECHNOLOGIES CO., LTD., Wuhan (CN)

(72) Inventor: Huadong HUANG, Wuhan (CN)

(21) Appl. No.: 19/049,853

(22) Filed: Feb. 10, 2025

(30) Foreign Application Priority Data
Mar. 7, 2024 (CN) 202410268733.7

(51) Int. Cl. G06F 12/02; G06F 12/1009

(52) U.S. Cl. CPC G06F 12/0253; G06F 12/0246; G06F 12/1009

(57) ABSTRACT

Examples of the present disclosure provide a memory system, a memory controller, a garbage collection method, and a storage medium. An example method includes: obtaining a first bitmap corresponding to a first source data block to a Nth bitmap corresponding to a Nth source data block; obtaining a merge bitmap based on the first bitmap to the Nth bitmap; reading a page table entry table according to the merge bitmap; writing valid data corresponding to the first source data block to the Nth source data block in the page table entry table into a target data block.

### CROSS-REFERENCE TO RELATED APPLICATIONS

The present application claims the benefit of priority to China Application No. 202410268733.7, filed on Mar. 7, 2024, the content of which is incorporated herein by reference in its entirety.

### TECHNICAL FIELD

The present disclosure relates to the field of semiconductor technology, and specifically, relates to a memory system, a memory controller, a garbage collection method, a computer program product and a storage medium.

### BACKGROUND

In memory technology, Garbage Collection (GC) is a basic function of various storage products (e.g., solid state drive (SSD), embedded memory device, etc.), and the main purpose of garbage collection is to migrate valid data on the source data block to the target data block so that the source data block can be reused. There is still room for further improvement in the efficiency of this garbage collection.

### SUMMARY

Examples of the present disclosure provide a memory system, a memory controller, a garbage collection method, a computer program product and a storage medium.

According to an aspect of an example of the present disclosure, a memory system is provided, including: a memory device; and a memory controller coupled to the memory device, wherein the memory controller is configured to: obtain the first bitmap corresponding to the first source data block to the Nth bitmap corresponding to the Nth source data block; N is an integer greater than or equal to 2; the bitmap containing an identifier directing to the page table entry table for the corresponding data block; obtain a merge bitmap based on the first bitmap to the Nth bitmap; read the page table entry table according to the merge bitmap; write valid data corresponding to the first source data block to the Nth source data block in the page table entry table into a target data block.

In some illustrated examples of the present disclosure, the memory controller is further configured to: search for valid data at physical addresses in the page table entry table which are located in the first source data block to the Nth source data block; write valid data at physical addresses in the page table entry table which are located in the first source data block to the Nth source data block into the target data block.

In some illustrated examples of the present disclosure, the memory controller is further configured to: in response to the valid data being written into the target data block, update a logical address to physical address mapping table; release the first source data block to the Nth source data block.

In some illustrated examples of the present disclosure, the memory controller is further configured to: perform an OR operation on bits corresponding to the first bitmap to the Nth bitmap to obtain the merge bitmap.

In some illustrated examples of the present disclosure, the memory controller is further configured to: match the data block bits of the physical addresses corresponding to the valid data in the page table entry table with the data block index values of the first source data block to the Nth source data block respectively, to determine valid data located in the first source data block to the Nth source data block.

In some illustrated examples of the present disclosure, the memory controller is further configured to: obtain the valid page counts of a plurality of or multiple data blocks; select the first source data block to the Nth source data block according to the valid page counts of the plurality of or the multiple data blocks.

In some illustrated examples of the present disclosure, the memory controller is further configured to: obtain the valid capacity of the target data block; select the first source data block to the Nth source data block according to the valid page counts of the plurality of or the multiple data blocks and the valid capacity of the target data block.

In some illustrated examples of the present disclosure, the memory controller is further configured to: select a plurality of or multiple data blocks; accumulate the valid page counts of the plurality of or the multiple data blocks; in response to the accumulated value for the valid page counts being no greater than the valid capacity of the target data block, select the first data blocks being accumulated as the first source data block to the Nth source data block.

In some illustrated examples of the present disclosure, the memory controller is further configured to: the selecting a plurality of or multiple data blocks including selecting a preset number of first data blocks.

In some illustrated examples of the present disclosure, the memory controller is further configured to: in response to the target data block being not fully written with data, obtain a (N+1)th source data block; according to a (N+1)th bitmap corresponding to the (N+1)th source data block, read the corresponding page table entry table; write at least part of the valid data corresponding to the (N+1)th source data block in the page table entry table into the target data block until the target data block is fully written.

In some illustrated examples of the present disclosure, the memory controller is further configured to: in response to the target data block being not fully written, write dummy data into the target data block until the target data block is fully written.

In some illustrated examples of the present disclosure, the memory controller is further configured to: determine proportions of valid data of respective data blocks in the plurality of or the multiple data blocks according to the valid page counts; select the first source data block to the Nth source data block from the plurality of or the multiple data blocks in which a proportion of valid data is lower than a preset threshold.

According to another aspect of an example of the present disclosure, a memory controller is provided, including: a controller memory configured to store control instructions; and a controller processor coupled to the controller memory and configured to execute the control instructions to perform a process, the process includes: obtaining the first bitmap corresponding to the first source data block to the Nth bitmap corresponding to the Nth source data block; N is an integer greater than or equal to 2; the bitmap containing an identifier directing to the page table entry table for the corresponding data block; obtaining a merge bitmap based on the first bitmap to the Nth bitmap; reading the page table entry table according to the merge bitmap; writing valid data corresponding to the first source data block to the Nth source data block in the page table entry table into a target data block.

In some illustrated examples of the present disclosure, the process further includes: searching for valid data at physical addresses in the page table entry table which are located in the first source data block to the Nth source data block; writing valid data at physical addresses in the page table entry table which are located in the first source data block to the Nth source data block into the target data block.

In some illustrated examples of the present disclosure, the process further includes: in response to the valid data being written into the target data block, updating a logical address to physical address mapping table; releasing the first source data block to the Nth source data block.

In some illustrated examples of the present disclosure, the process further includes: performing an OR operation on bits corresponding to the first bitmap to the Nth bitmap to obtain the merge bitmap.

In some illustrated examples of the present disclosure, the process further includes: matching the data block bits of the physical addresses corresponding to the valid data in the page table entry table with the data block index values of the first source data block to the Nth source data block respectively, to determine valid data located in the first source data block to the Nth source data block.

In some illustrated examples of the present disclosure, the process further includes: obtaining the valid page counts of a plurality of or multiple data blocks; selecting the first source data block to the Nth source data block according to the valid page counts of the plurality of or the multiple data blocks.

In some illustrated examples of the present disclosure, the process further includes: obtaining the valid capacity of the target data block; selecting the first source data block to the Nth source data block according to the valid page counts of the plurality of or the multiple data blocks and the valid capacity of the target data block.

In some illustrated examples of the present disclosure, the process further includes: selecting a plurality of or multiple first data blocks; accumulating the valid page counts of the plurality of or the multiple first data blocks; in response to the accumulated value for the valid page counts being no greater than the valid capacity of the target data block, selecting the first data blocks being accumulated as the first source data block to the Nth source data block.

In some illustrated examples of the present disclosure, the process further includes: the selecting a plurality of or multiple first data blocks including selecting a preset number of first data blocks.

In some illustrated examples of the present disclosure, the process further includes: in response to the target data block being not fully written, obtaining a (N+1)th source data block; according to a (N+1)th bitmap corresponding to the (N+1)th source data block, reading the corresponding page table entry table; writing at least part of the valid data corresponding to the (N+1)th source data block in the page table entry table into the target data block until the target data block is fully written.

In some illustrated examples of the present disclosure, the process further includes: in response to the target data block being not fully written, writing dummy data into the target data block until the target data block is fully written.

In some illustrated examples of the present disclosure, the process further includes: determining proportions of valid data of respective data blocks in the plurality of or the multiple data blocks according to the valid page counts; selecting the first source data block to the Nth source data block from the plurality of or the multiple data blocks with a proportion of valid data being lower than a preset threshold.

According to yet another aspect of the examples of the present disclosure, a garbage collection method is provided, including: obtaining the first bitmap corresponding to the first source data block to the Nth bitmap corresponding to the Nth source data block; N is an integer greater than or equal to 2; the bitmap containing an identifier directing to the page table entry table for the corresponding data block; obtaining a merge bitmap based on the first bitmap to the Nth bitmap; reading the page table entry table according to the merge bitmap; writing valid data corresponding to the first source data block to the Nth source data block in the page table entry table into a target data block.

In some illustrated examples of the present disclosure, the writing valid data corresponding to the first source data block to the Nth source data block in the page table entry table into a target data block includes: searching for valid data at physical addresses in the page table entry table which are located in the first source data block to the Nth source data block; writing valid data located in the first source data block to the Nth source data block into the target data block.

In some illustrated examples of the present disclosure, the process further includes: according to the valid data being written into the target data block, updating a logical address to physical address mapping table; releasing the first source data block to the Nth source data block.

In some illustrated examples of the present disclosure, the obtaining a merge bitmap based on the first bitmap to the Nth bitmap includes: performing an OR operation on bits corresponding to the first bitmap to the Nth bitmap to obtain the merge bitmap.

In some illustrated examples of the present disclosure, the searching for valid data at physical addresses in the page table entry table which are located in the first source data block to the Nth source data block includes: matching the data block bits of the physical addresses corresponding to the valid data in the page table entry table with the data block index values of the first source data block to the Nth source data block respectively, to determine valid data located in the first source data block to the Nth source data block.

In some illustrated examples of the present disclosure, the process further includes: obtaining the valid page counts of a plurality of or multiple data blocks; selecting the first source data block to the Nth source data block according to the valid page counts of the plurality of or the multiple data blocks.

In some illustrated examples of the present disclosure, the selecting the first source data block to the Nth source data block according to the valid page counts of the plurality of or the multiple data blocks includes: obtaining the valid capacity of the target data block; selecting the first source data block to the Nth source data block according to the valid page counts of the plurality of or the multiple data blocks and the valid capacity of the target data block.

In some illustrated examples of the present disclosure, the selecting the first source data block to the Nth source data block according to the valid page counts of the plurality of or the multiple data blocks and the valid capacity of the target data block includes: selecting a plurality of or multiple first data blocks; accumulating the valid page counts of the plurality of or the multiple first data blocks; in response to the accumulated value for the valid page counts being no greater than the valid capacity of the target data block, selecting the first data blocks being accumulated as the first source data block to the Nth source data block.

In some illustrated examples of the present disclosure, the selecting a plurality of or multiple firsts data blocks includes: the selecting a plurality of or multiple data blocks including selecting a preset number of first data blocks.

In some illustrated examples of the present disclosure, the process further includes: in response to the target data block being not fully written, obtaining the (N+1)th source data block; according to the (N+1)th bitmap corresponding to the (N+1)th source data block, reading the corresponding page table entry table; writing at least part of the valid data corresponding to the (N+1)th source data block in the page table entry table into the target data block until the target data block is fully written.

In some illustrated examples of the present disclosure, the process further includes: in response to the target data block being not fully written, writing dummy data into the target data block until the target data block is fully written.

In some illustrated examples of the present disclosure, the selecting the first source data block to the Nth source data block according to the valid page counts of the plurality of or the multiple data blocks includes: determining proportions of valid data of respective data blocks in the plurality of or the multiple data blocks according to the valid page counts; selecting the first source data block to the Nth source data block from the plurality of or the multiple data blocks with a proportion of valid data being lower than a preset threshold.

According to yet another aspect of an example of the present disclosure, a non-transitory, computer-readable storage medium is provided, wherein when the control instructions in the computer-readable storage medium are executed by a controller processor, enable the controller processor to perform the garbage collection method of a memory of any aspect.

According to yet another aspect of an example of the present disclosure, a computer program product is provided, which includes computer programs/instructions, the computer programs/instructions, when executed by a processor, implement the garbage collection method mentioned in any of the above examples.

The memory system, memory controller and garbage collection method provided by examples of the present disclosure perform garbage collection operation on multiple source data blocks, through merging the corresponding bitmaps of multiple source data blocks, a merge bitmap is obtained, then the corresponding page table entry table is read based on the merge bitmap, thereby avoiding the response latency caused by repeated reading of the page table entry table for respective source data blocks, and improving the process efficiency of the overall garbage collection process.

It should be understood that the foregoing general description and the following detailed description are illustrated and explanatory only, and do not limit the present disclosure.

### BRIEF DESCRIPTION OF THE DRAWINGS

The accompanying drawings, which are incorporated in and constitute a part of the present description, illustrate examples consistent with the disclosure and are used to explain the principles of the disclosure together with the description. Apparently, the accompanying drawings in the following description are only some examples of the application, and for those skilled in the art, other drawings may also be obtained according to these accompanying drawings without any creative effort.

FIG. 1A is a schematic diagram of an illustrated system with a memory system according to an example of the present disclosure;

FIG. 1B is a schematic diagram of an illustrated memory card with a memory system according to an example of the present disclosure;

FIG. 1C is a schematic diagram of an illustrated solid state drive with a memory system according to an example of the present disclosure;

FIG. 2 is a schematic diagram of an illustrated memory controller with a memory system according to an example of the present disclosure;

FIG. 3 is a schematic flowchart 1 of a garbage collection method of a memory provided by an example of the present disclosure;

FIG. 4 is a schematic structural diagram of a valid data address mapping table of a memory according to an example of the present disclosure;

FIG. 5 is a schematic diagram of a garbage collection process of a memory according to an example of the present disclosure;

FIG. 6 is a schematic flowchart 1 of a garbage collection method of a memory provided by an example of the present disclosure;

FIG. 7 is a schematic flowchart of matching of valid data addresses according to an example of the present disclosure;

FIG. 8 is a schematic flowchart 1 of selecting a source data block according to an example of the present disclosure;

FIG. 9 is a schematic flowchart 2 of selecting a source data block according to an example of the present disclosure;

FIG. 10 is a schematic flowchart 1 of valid data migration according to an example of the present disclosure;

FIG. 11 is a schematic diagram of valid data migration process according to an example of the present disclosure;

FIG. 12 is a schematic flowchart 2 of valid data migration according to an example of the present disclosure; and

FIG. 13 is a schematic flowchart 3 of selecting a source data block according to an example of the present disclosure.

### DETAILED DESCRIPTION

Examples will now be described more fully with reference to the accompanying drawings. Examples may, however, be embodied in various forms and should not be construed as limited to the examples set forth herein; rather, these examples are provided so that this disclosure will be thorough and complete, and will fully convey the concepts of examples to those skilled in the art. Same reference numerals in the accompanying drawings represent same or similar parts, and thus repeated description thereof will be omitted.

The features, structures, or characteristics described in this disclosure may be combined in any suitable manner in one or more examples. In the following description, numerous specific details are provided to provide a thorough understanding of examples of the disclosure. However, those skilled in the art will appreciate that the technical solutions of the present disclosure may be practiced with one or more of the specific details being omitted, or by employing other methods, components, devices, operations, etc. In other instances, well-known methods, apparatus, implementations, or operations are not shown or described in detail to avoid obscuring aspects of the present disclosure.

The accompanying drawings are merely schematic illustrations of the present disclosure, and same reference numerals in the accompanying drawings represent same or similar parts, and thus repeated description thereof will be omitted. Some of the block diagrams shown in the accompanying drawings do not necessarily correspond to physically or logically separate entities. These functional entities may be implemented in software form, or implemented in at least one hardware modules or integrated circuits, or implemented in at least one of different networks or processor devices or micro-controller devices.

The flowcharts shown in the drawings are only illustrative, and do not necessarily include all contents and operations, nor must they be executed in the order described. For example, some operations may be decomposed, and some operations may be combined or partially combined, thus the actual order of execution may change according to the actual situation.

In this specification, the terms “a”, “an”, “this”, “the” and “at least one” are used to indicate the presence of at least one element/component/etc.; the words “comprising”, “including” and “having” are used to express an open inclusion and mean that there may be additional elements/components/etc., in addition to the listed elements/components/etc.; and the terms “first”, “second” and “third” etc. are used only as labels and not as quantitative limitations to their objects.

One implementation of garbage collection operation is to migrate data block by block, that is, another data block is migrated after one data block. This method requires reading the data mapping table multiple times. Reading the data mapping table requires a large time cost. Generally, garbage collection involves the process of a plurality of or multiple data blocks, making the garbage collection operation less efficient.

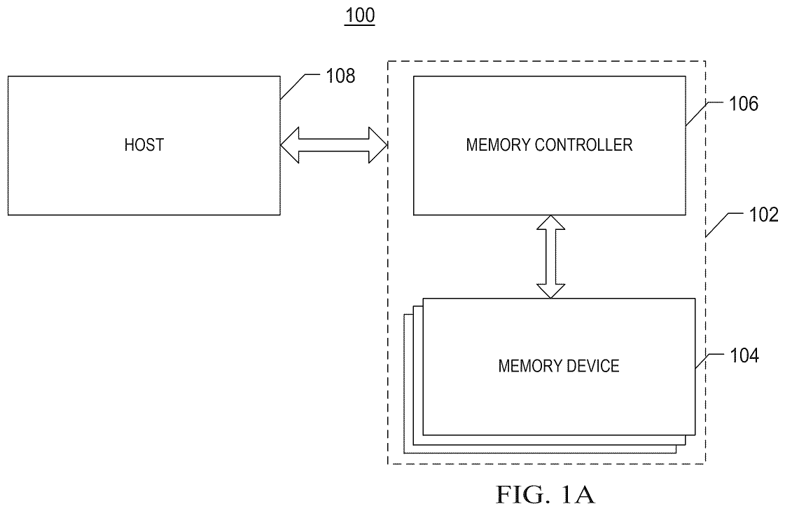

FIG. 1A is a schematic diagram of an illustrated system with a memory system according to an example of the present disclosure. The system 100 may be a mobile phone, a desktop computer, a portable computer, a tablet computer, a vehicle computer, a gaming console, a printer, a positioning device, a wearable electronic device, a smart sensor, a Virtual Reality (VR) device, an Augmented Reality (AR) device, or any other suitable electronic devices having one or more memory devices therein. As shown in FIG. 1A, the system 100 may include a host 108 and a memory system 102 having one or more memory devices 104 and a memory controller 106.

The host 108 may be a processor of an electronic device (e.g., a Central Processing Unit (CPU)) or a System on Chip (SoC) (e.g., an Application Processor (AP)). Host 108 may be coupled to memory controller 106 and configured to send data to or receive data from memory device 104 through memory controller 106. For example, host 108 may send program data during a programming operation or receive read data during a reading operation. The host 108 is configured to receive instructions and commands from and send instructions and commands to the memory controller 106 of the memory system 102 and to perform or implement the various functions and operations provided in this disclosure, which will be described below.

Memory device 104 may be any memory device disclosed in this disclosure, e.g., a NAND flash memory device that includes a page buffer with multiple sections. It is to be noted that for illustrative purposes, NAND flash memory is only one example of a memory device. The memory device 104 may include any suitable solid-state non-volatile memory, e.g., NOR flash memory, Ferroelectric Random Access Memory (FeRAM), Phase Change Memory (PCM), Magnetic Random Access Memory (MRAM), Spin-Transfer Torque Random Access Memory (STT-RAM) or Resistive Random Access Memory (RRAM), etc. In some implementations, memory device 104 includes three-dimensional (3D) NAND flash memory.

The memory controller 106 may be implemented by: microprocessor, microcontroller (also known as a microcontroller unit (MCU)), Digital Signal Processor (DSP), Application Specific Integrated Circuit (ASIC), Field-Programmable Gate Array (FPGA), Programmable Logic Device (PLD), state machine, gate control logic, discrete hardware circuits and other suitable hardware, at least one of firmware or software configured to perform the various functions described in detail below.

According to some implementations, memory controller 106 is coupled to memory device 104 and host 108 and is configured to control memory device 104. The memory controller 106 may manage data stored in the memory device 104 and communicate with the host 108. In some implementations, the memory controller 106 is designed to operate in low duty cycle environments, e.g., Secure Digital (SD) card, Compact Flash (CF) card, Universal Serial Bus (USB) flash drive, or other media for use in an electronic device (e.g., personal computer, digital camera, mobile phone, etc.). In some implementations, memory controller 106 is designed to operate SSDs in high duty cycle environments or for use as data memory devices for mobile devices (e.g., smartphones, tablets, laptops, etc.) and Embedded MultiMedia Card (eMMC) for enterprise storage arrays. The memory controller 106 may be configured to control operations of memory device 104, such as read, erase, and program operations, through providing instructions to the memory device 104, such as read instruction. For example, the memory controller 106 may be configured to provide read instruction to peripheral circuit of memory device 104 to control read operation. The memory controller 106 may be further configured to manage various functions related to data stored or to be stored in memory device 104, including but not limited to bad block management, Garbage Collection (GC), logical address to physical address translation, wear leveling, etc. In some implementations, the memory controller 106 is further configured to process Error Correcting Code (ECC) related to data read from or written to memory device 104. The memory controller 106 may also perform any other suitable functions, e.g., formatting memory device 104.

The memory controller 106 may communicate with external devices (e.g., host 108) according to a particular communication protocol. For example, memory controller 106 may communicate with an external device through at least one of various interface protocols, such as USB protocol, MMC (Multi Media Card) protocol, Peripheral Component Interconnect (PCI) protocol, Peripheral Component Interconnect Express (PCI-E) protocol, Advanced Technology Attachment (ATA) protocol, Serial ATA protocol, Parallel ATA protocol, Small Computer System Interface (SCSI) protocol, Enhanced Small Drive Interface (ESDI) protocol, Integrated Drive Electronics (IDE) protocol, Firewire protocol, etc.

The memory controller 106 and one or more memory device 104 may be integrated into various types of memory devices, e.g., included in the same package (e.g., Universal Flash Storage (UFS) package or eMMC package). That is, the memory system 102 may be implemented and packaged into different types of terminal electronic products.

In an example as shown in FIG. 1B, the memory controller 106 and the memory device 104 may be integrated into a memory card 202. The memory card 202 may include a PC card (PCMCIA (Personal Computer Memory Card International Association) card), CF card, Smart Media (SM) card, memory stick, multimedia card (MMC), SD card, UFS, etc. Memory card 202 may further include a memory card connector 204 coupling memory card with a host (e.g., host 108 in FIG. 1).

In another example as shown in FIG. 1C, the memory controller 106 and multiple memory devices 104 may be integrated into the solid state drive 206. The solid state drive 206 may also include a solid state drive connector 208 coupling the solid state drive 206 with a host (e.g., host 108 in FIG. 1). In some implementations, at least one of the storage capacity or operating speed of the solid state drive 206 is greater than that of the memory card 202.

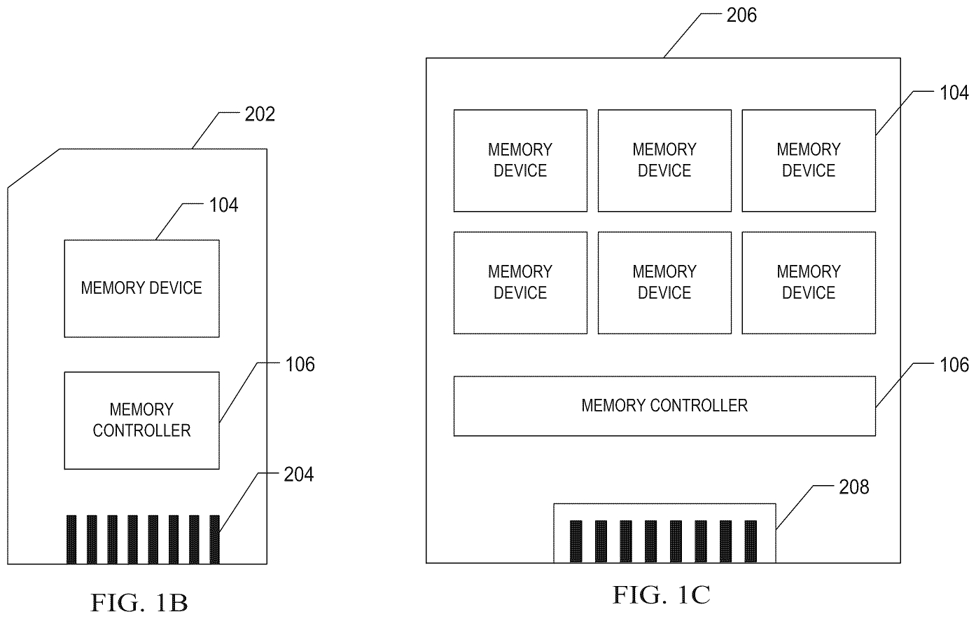

FIG. 2 is a schematic diagram of an illustrated memory controller with a memory system according to an example of the present disclosure. As shown in FIG. 2, the memory controller 106 is coupled to the host 108 and one or more memory devices 104 respectively, and is used to control the host 108 to send data to the memory device 104 or to read data from the memory device 104 and return it to the host 108. The memory controller 106 at least includes: a controller processor 210, a host interface controller 211, a memory device interface controller 212, a controller memory 213, a hardware accelerator 214 and a buffer 215.

The controller processor 210 is the core part of the memory controller, which is used to perform the control logic and algorithms of the memory controller, and is responsible for functions such as processing command queues, address mapping, garbage collection, data compression, input and output control. The controller processor 210 may be implemented by an embedded processor or FPGA.

The host interface controller 211 is coupled to the host 108 and the controller processor 210 respectively, which is a communication interface component between the host and the memory controller and is responsible for data transmission between the host and the memory controller, including data reading and writing, and receiving and sending commands. It usually supports various interfaces (e.g., SATA (Serial Advanced Technology Attachment), PCIe) and protocols (e.g., AHCI (Advanced Host Controller Interface), NVMe (Non-Volatile Memory Express)), and provides data transmission functions.

The memory device interface controller 212 is coupled to the memory device 104 and the controller processor 210 respectively, which is a communication interface component between the memory device and the memory controller, and is responsible for implementing functions such as data reading and writing, erasing, and address mapping.

The controller memory 213, coupled with the controller processor 210, is a storage area used to store instructions and data of the controller, and may provide fast read and write operations and real-time control functions. A controller memory usually employs storage media such as NOR flash, NAND flash or RAM.

The hardware accelerator 214, coupled to the controller processor 210, is a component optimized for certain operations. It optimizes the performance of certain operations through hardware logic circuits to improve the performance and data security of memory devices. For example, a hardware accelerator may be used to handle tasks such as encryption, decryption, compression, decompression, error correction codec, etc. Additionally, it may be further used to improve operations such as data searching and ordering.

The buffer 215, coupled to the controller processor 210, is a component used to temporarily store data, and may also be used to cache instructions and data. It usually employs high-speed memory devices such as Dynamic Random-Access Memory (DRAM) and Static Random-Access Memory (SRAM) to improve the read and write performance of the memory controller and reduce latency.

The memory controller 106 is configured to receive commands from and send commands to the host 108 and to perform or implement a number of functions and operations provided in the present disclosure, which will be described below.

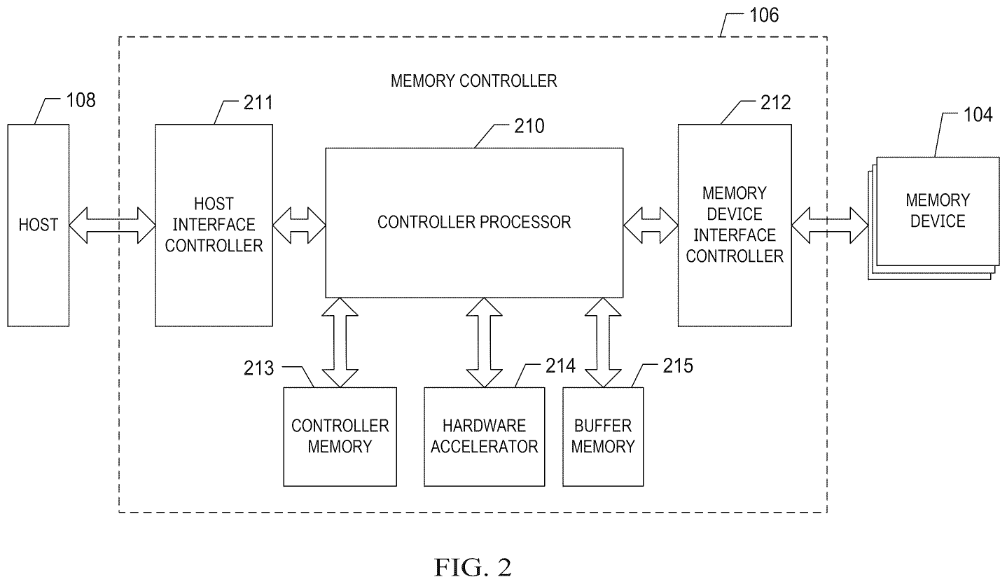

FIG. 3 is a schematic flowchart of a garbage collection method according to an example of the disclosure, as shown in FIG. 3, the garbage collection method provided in the example of the disclosure may be applied to the memory controller shown in FIG. 2.

The garbage collection method of an example of the present disclosure may include S310, in S310, the first bitmap corresponding to the first source data block to the Nth bitmap corresponding to the Nth source data block is obtained; N is an integer greater than or equal to 2; the bitmap containing an identifier directing to the Page Table Entry (PTE) table of the corresponding data block.

In the example of the present disclosure, the garbage collection process is to copy the valid data stored in the data block to be recycled to other data blocks, and then perform garbage collection on the data block to be recycled in order to reuse the data block. During the garbage collection process, the data block to be recycled is the source data block, and the data block to which the valid data is copied is the target data block.

In some examples, an important function of memory controller 106 includes completing a conversion from the logical address space (e.g., Logic Block Address, LBA) of host 108 to the physical address space of the memory device 104 (e.g., Physical Cluster Address, PCA), the memory controller 106 writes a batch of user data into the memory device 104, the memory controller 106 calculates the logical block address LBA involved in the write request sent by the host 108, and obtains the corresponding Logic Cluster Address (LCA), then allocate a physical address space such as physical cluster address PCA to the user data, stores the batch of user data in the corresponding physical cluster address PCA, and records the mapping from the logical cluster address LCA to the physical cluster address PCA of the batch of user data, i.e., the mapping relationship between logical cluster address and physical cluster address, and when the host 108 reads the data, the memory system 102 reads the batch of data from the memory device 104 and returns it to the host 108 according to this mapping relationship.

When the memory controller 106 manages the physical storage space of the memory device 104, the entire physical storage space of the memory device 104 may be evenly divided into multiple logical storage spaces for coverage expression accordingly, multiple logical storage spaces may cover the entire physical storage space of the memory device 104, and each logical storage space accordingly has a logical cluster address LCA. In some examples, each logical storage space may correspond to 4K of storage space.

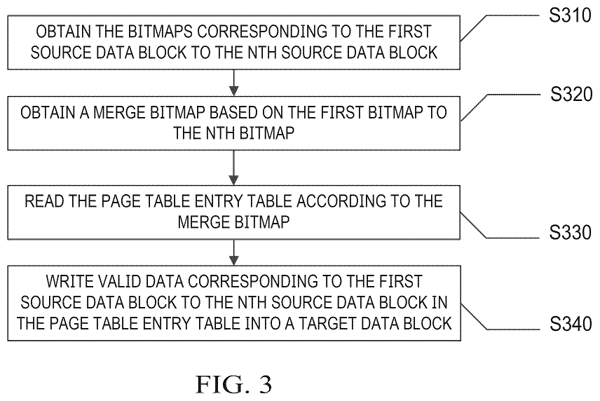

The memory controller 106 may internally maintain a Logical-to-Physical Mapping Table (L2P mapping table) to convert the logical block address recognized by the host 108 and the physical cluster address of the memory device, where the L2P mapping table includes all mapping relationships between logical cluster addresses and physical cluster addresses. As shown in FIG. 4, the physical cluster address PCA of the memory device 104 which the logical cluster address is mapped to may be determined by merging the L2P mapping table. In order to shorten the read delay of the host, the L2P mapping table is preferably placed in the memory of the memory controller (e.g., the buffer 215 in FIG. 2) or a cache which may communicate with the memory controller. In some examples, the memory of the memory controller or the cache in communication with the memory controller may include a volatile memory device, e.g., may include, but is not limited to, a Static Random Access Memory (SRAM), a Dynamic Random Access Memory (DRAM), etc.

Several solutions may be used to store and maintain the L2P mapping table. One scheme is single-level direct L2P mapping scheme, which may contain mapping information for data in an entire memory device. Therefore, the single-level direct page mapping scheme requires a large amount of storage space (1 GB of data corresponds to the order of storing an L2P mapping table of 1-2 MB) to store the L2P mapping table, which is a challenge for a large-capacity memory device, especially for DRAM-less memory systems such as DRAM-less SSDs. The mapping table corresponding to the single-level direct L2P mapping scheme may be referred to as a Page Table Entry (PTE) table, which stores the physical address at which the data is located (e.g., the physical cluster address PCA).

Another scheme for storing and maintaining a L2P mapping table is a multi-level mapping scheme, here, a three-level mapping scheme is used as an example for illustration, as shown in FIG. 4, the first-level mapping table may be referred to as a Page Global Directory or page directory (PGD) table, which stores the physical address of the second-level mapping table (e.g., the physical cluster address PCA), and each mapping item in the first-level mapping table directs to a second-level mapping table; the second-level mapping table may be referred to as a Page Middle Directory (PMD) table, which stores the physical address of the third-level mapping table (e.g., the physical cluster address PCA), and each mapping item in the second-level mapping table directs to a third-level mapping table; the third-level mapping table page may be referred to as a Page Table Entry (PTE) table, which stores the physical address where the data is located (e.g., the physical cluster address PCA). It should be clear that no matter which level of mapping scheme is employed, the last level mapping table may be used as a Page Table Entry (PTE) table, which stores the physical address where the data is located (e.g., the physical cluster address PCA).

The memory controller 106 evenly divides all physical storage spaces of the memory device 104 into multiple logical storage spaces for coverage expression, and accordingly allocates a logical cluster address LCA to each logical storage space, the memory controller 106 may number the multiple logical cluster addresses LCA starting from 0 (LCA0) and order them starting from LCA0 in the page table entry table, and each logical cluster address LCA has its fixed position in the page table entry table. For example, referring to FIG. 4, each page table entry table includes 1024 entries, and each entry may include a physical cluster address PCA mapped with the logical cluster address LCA, and correspond to a 4K of storage space, therefore, each page table entry table may correspond to 4M of user data.

In the multi-level mapping scheme, the first-level mapping table may be stored in the memory of the memory controller 106, that is, the first-level mapping table is resident in the memory of the memory controller 106, and some of the mapping tables at other levels are stored in the memory of the memory controller 106, when the L2P mapping relationship corresponding to the logical block address involved in the read request of the host is not in the memory of the memory controller 106, the memory controller needs to firstly read the corresponding L2P mapping relationship from the memory device 104 into the memory of the memory controller 106 and then perform the read operation corresponding to the read request of the host.

In an illustrated example, as shown in FIG. 4, PMD index 0 in the PGD table 410 is mapped to a PMD table 420. The PMD table 420 contains PTE index 0 to PTE index 1023. The PTE index 0 in the PMD table 420 is mapped to a PTE table 430. The PTE table 430 contains logical cluster addresses LCA0 to LCA1023. As shown in the figure, the physical cluster address PCA corresponding to LCA0 directs to the data in a physical space in data block 1, the physical cluster address PCA corresponding to LCA1 directs to the data in a physical space in data block 2, and the physical cluster address PCA corresponding to LCA1023 directs to the data in a physical space in data block N. In the storage system, each data block corresponds to a bitmap. A bitmap is a data structure that usually consists of consecutive binary bits, each bit representing a certain state or referring to some kind of information. Each bit in the bitmap may take the value 0 or 1, corresponding to a PTE table. For example, when a bit in the bitmap has a value of 0, it means that no L2P mapping relationship corresponding to directing to the valid data in the data block exists in the corresponding PTE table; when a bit in the bitmap has a value of 1, it means that a L2P mapping relationship corresponding to directing to the valid data in the data block exists in the corresponding PTE table.

During the garbage collection process, valid data in the source data block is migrated to the target data block to perform garbage collection on the source data block. Therefore, in S310, the first bit image corresponding to the first source data block to the Nth bitmap corresponding to the Nth source data block are respectively obtained, where N is an integer greater than or equal to 2. Each bitmap records the PTE table where the L2P mapping relationship corresponding to the valid data in the corresponding data block is located.

For example, six source data blocks are selected for garbage collection during the garbage collection process, that is, N=6. The six source data blocks are respectively a first source data block, a second source data block, a third source data block, a fourth source data block, a fifth source data block and a sixth source data block. As described above, each data block corresponds to a bitmap. The six source data blocks described above correspond to the first bitmap, the second bitmap, the third bitmap, the fourth bitmap, the fifth bitmap, and the sixth bitmap respectively. It should be noted that the N described above is used to represent the number of selected source data blocks. Among them, “first”, “second”, “third” . . . “Nth”, etc., are only used as labels to distinguish different source data blocks and bitmaps, and would not be a limit on their number or order.

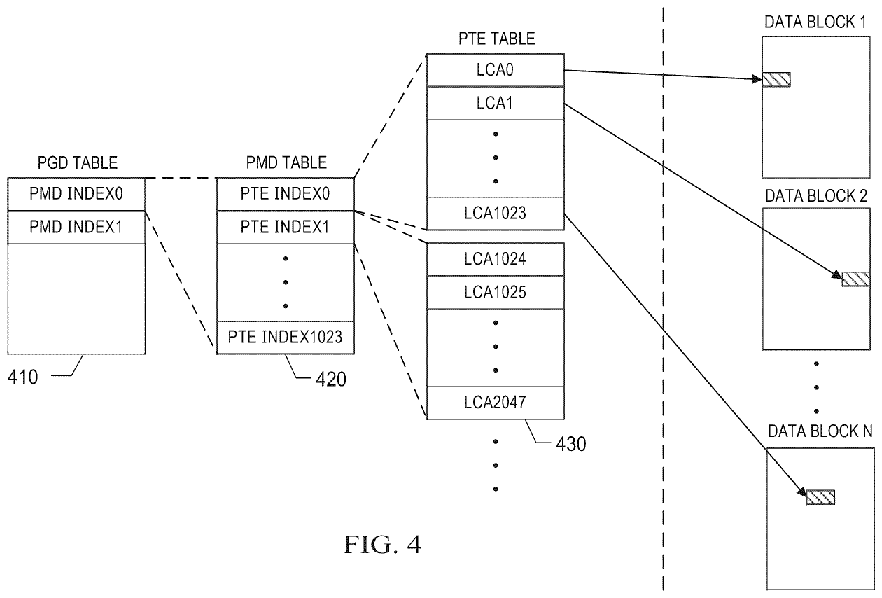

In an illustrated example, as shown in FIG. 5, each data block corresponds to a bitmap, and respective bits in the bitmap correspond to different PTE tables from left to right, PTE0, PTE1, PTE2. . . . PTE N, respectively. As shown in the figure, the Bitmap1 corresponding to source data block 1 is “000001000000000001 . . . ”, which means that L2P mapping relationships corresponding to the valid data directing to source data block 1 exist in PTE5 and PTE17; the Bitmap2 corresponding to source data block 2 is “000100000000000001 . . . ”, which means that L2P mapping relationships corresponding to the valid data directing to source data block 2 exist in PTE3 and PTE17; the BitmapN corresponding to source data block N is “000100000010000000 . . . ”, which means that L2P mapping relationships corresponding to the valid data directing to source data block N exist in PTE3 and PTE10.

In an illustrated example, the obtained bitmaps corresponding to respective source data blocks may be temporarily stored in a buffer of the memory controller.

Continuing to refer to FIG. 3, the garbage collection method according to an example of the present disclosure may include S320, and in S320, a merge bitmap is obtained based on the first bitmap to the Nth bitmap.

After obtaining the bitmap corresponding to the source data block, the corresponding PTE table may be read according to the identification bit of the bitmap, e.g., the valid data may be migrated one by one according to the identification bit of the bitmap of each source data block, which increases the possibility of repeatedly reading the same PTE table, e.g., see FIG. 5, when migrating valid data from source data block 1, it is required to read PTE17, and when migrating valid data from source data block 2, it is required to read PTE17 again, which causes a high overall response latency.

Valid Data in the example of the present disclosure, in S310, the first bitmap to the Nth bitmap corresponding to the first source data block to the Nth source data block are obtained respectively. And the first bitmap to the Nth bitmap are merged to obtain a merge bitmap. The merge of multiple bitmaps involves performing an OR operation on the corresponding bits of the multiple bitmaps to obtain the merge bitmap.

In an illustrated example, as shown in FIG. 5, Bitmap1 corresponding to source data block 1 is “000001000000000001 . . . ”, Bitmap2 corresponding to source data block 2 is “000100000000000001 . . . ”, and Bitmap N corresponding to source data block N is “000100000010000000 . . . ”. Therefore, the merge bitmap is calculated based on the following:

Merge bitmap=Bitmap1|Bitmap2| . . . |Bitmap N=000101000010000001 . . .

In an illustrated example, the controller processor reads the obtained respective bitmaps from the buffer, merges respective bitmaps in S320 in the controller processor, and temporarily stores the obtained merge bitmap into the buffer of the memory controller.

In operation S330, the page table entry table is read according to the merge bitmap.

In this example of the present disclosure, the corresponding PTE table is read according to respective identification bits in the merge bitmap.

In an illustrated example, as shown in FIG. 5, the merge bitmap obtained based on the merge calculation described above is “000101000010000001 . . . ”, which corresponds to directing to PTE3, PTE5, PTE10 and PTE17. The corresponding PTE3, PTE5, PTE10 and PTE17 are read based on the merge bitmap. It may be seen that reading the PTE table based on this merge bitmap may avoid repeated reading of PTE17 based on Bitmap1 and Bitmap2, and may also avoid repeated reading of PTE3 based on Bitmap2 and BitmapN, saving the response time cost of repeatedly reading the related PTE table.

In operation S340, valid data corresponding to the first source data block to the Nth source data block in the page table entry table is written into a target data block.

The PTE table stores the mapping relationships between the logical addresses and the physical addresses of respective data. At least one PTE table corresponding to the merge bitmap is read through operation S330. The at least one related PTE table corresponds to at least one source data block among the aforementioned first source data block to the Nth source data block. The mapping relationships between the logical addresses and the physical addresses corresponding to the first source data block to the Nth source data block are read according to the at least one PTE table, and the logical addresses and physical addresses of the related valid data are pushed to the retrieval queue. The related valid data is read by reading the logical address and physical address of the valid data in the retrieval queue, and the related valid data is written into the preset target data block.

In an illustrated example, as shown in FIG. 5, the logical addresses/physical addresses of the valid data corresponding to the first source data block to Nth source data block are read from the PTE table by merging the bitmap and pushed to the retrieval queue. The retrieval queue includes logical address/physical address pairs: LCA0/PCA0, LCA1/PCA1, . . . , LCAn/PCAn. Related valid data is read respectively according to the logical address/physical address pairs, and the related valid data is written into the target data block.

In an illustrated example, the garbage collection method of a memory may be implemented by a computer program/instruction executed by a processor. The computer program/instructions may be stored in the controller memory in a memory controller, or a hardware accelerator. The computer program/instructions are called and executed by the controller processor when the memory system requires garbage collection. The data during execution of the computer program/instructions may be temporarily stored in the buffer.

The garbage collection method provided by the example of the present disclosure performs garbage collection operations on multiple source data blocks, and obtains a merge bitmap through merging the bitmaps corresponding to the multiple source data blocks. And the corresponding page table entry table is read through the merge bitmap, thereby avoiding the response latency caused by repeated reading of the page table entry table between respective source data blocks, and improving the process efficiency of the overall garbage collection process.

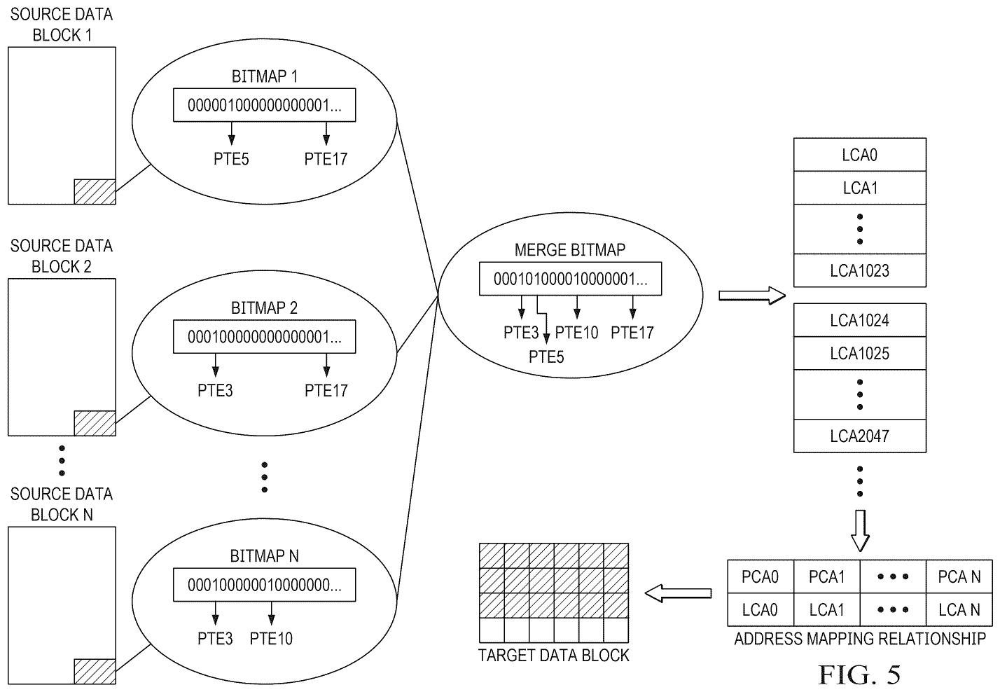

FIG. 6 is a schematic flowchart 1 of a garbage collection method of a memory provided by an example of the present disclosure. In the example of the present disclosure, operations S610, S620, S630, and S640 in the garbage collection method shown in FIG. 6 respectively correspond to operations S310, S320, S330, and S340 in the garbage collection method shown in FIG. 3, which will not be repeated here for the sake of brevity. Based on the foregoing garbage collection method of a memory, the method may also include the following operations. This method may be applied to the memory controller shown in FIG. 2.

In operation S650, a logical address to physical address mapping table (L2P) is updated according to the valid data being written into the target data block.

The PTE table stores the mapping relationships between the logical addresses and the physical addresses of respective data, that is, the Logical address To Physical address mapping table (L2P). In the operation S340, the PTE table determines the address mapping relationship LCA/PCA of the valid data, and then writes the related valid data into the target data block. In the process of writing the valid data into the target data block, the new physical address PCA′ of the valid data in the target data block is obtained. Based on the new physical address PCA′, the original address mapping relationship LCA/PCA in the PTE table is updated to obtain the updated address mapping relationship LCA/PCA′.

Through updating the address mapping relationship in the PTE table, when subsequent programs access the valid data based on the logical address LCA, the valid data may be accessed at the corresponding physical address in the target data block based on the updated address mapping relationship LCA/PCA′.

In a memory system, the address mapping relationships between logical addresses and physical addresses are usually managed through a multi-level mapping table. According to the requirements of memory system address mapping relationship management, in addition to the update of the PTE table described above, synchronous updates of the PGD table and the PMD table may also be involved.

In addition, as the valid data is migrated from the source data block to the target data block, the PTE table described above is updated, and the bitmaps corresponding to the first source data block to the Nth source data block and the target data block are updated synchronously, and the bit value of Bitmap corresponding to the migrated valid data is changed from 1 to 0.

In operation S660, the first source data block to the Nth source data block is released.

In the example of the present disclosure, after completing the migration of the related valid data in the first source data block to the Nth source data block, the original physical address PCA of the related valid data may be marked as idle or invalid, so as to realize the release of the source data block. After the valid data of the related source data block is released, a garbage collection operation may be performed on the source data block, so that the storage space of the source data block is released and may be reused for data writing.

The garbage collection method provided by the example of the present disclosure synchronously updates the address mapping relationship of the related valid data in the PTE table during the process of migrating valid data from the source data block to the target data block, and releases the storage space of the valid data in the first source data block to the Nth source data block. It is ensured that the valid data may be normally read at the host side, and that the first source data block to the Nth source data block may be garbage collected.

In the example of the present disclosure, as shown in FIG. 4, the PTE table includes multiple sets of address mapping relationships LCA/PCA. Among them, there may be some address mapping relationships LCA/PCA corresponding to the valid data in the first source data block to the Nth source data block. Based on this, the operation S340 may include the following operations.

Operation S340A: search for valid data at physical addresses in the page table entry table which are located in the first source data block to the Nth source data block.

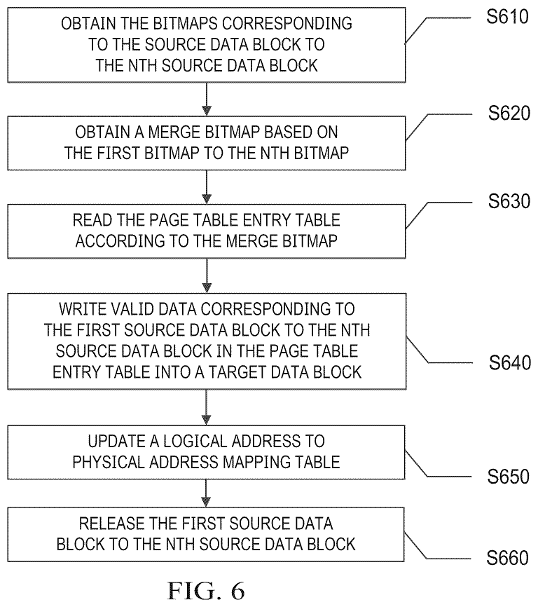

In the example of the present disclosure, multiple sets of physical addresses in the PTE table are matched with the physical addresses of the first to Nth source data blocks, and valid data at physical addresses located in the first source data block to the Nth source data block is searched. FIG. 7 is a schematic flowchart of matching of valid data addresses according to an example of the present disclosure. As shown in the figure, the process of the matching of valid data addresses may include the following operations.

In operation S710, the physical address of the valid data in the page table entry table is read.

In the example of the present disclosure, the PTE table corresponding to the merge bitmap is read based on the aforementioned operation S330, and the physical addresses in the address mapping relationships of respective valid data in the PTE table are further read. Here, reading the physical addresses of respective valid data in the PTE table may be implemented by hardware or software. This disclosure does not limit to this.

In operation S720, the physical addresses corresponding to the valid data in the page table entry table are matched with the first source data block to the Nth source data block respectively.

In the example of the present disclosure, a physical address is usually a binary data structure, which includes data block bits corresponding to the index value of the data block. The data block bits are a portion of the fields in the physical address and are used to identify the data block corresponding to the physical address. The index value of the data block refers to the value used to uniquely identify the position of the data block in the physical address space. The related fields in the physical addresses of respective valid data in the PTE table are matched with the index values of the first source data block to the Nth source data block to determine which valid data in the PTE table is located in the first source data block to the Nth source data block.

In an illustrated example, the physical address is a 32-bit binary number, in which the data block bit (denoted as VB_bit) corresponds to the index value of the data block (denoted as VB_index). The physical address of the valid data in the PTE table is matched with the index value of the data block, that is, an “XOR” operation on the VB_bit and VB_index bit by bit is performed. If result of the XOR operation is 0, it means that VB_bit matches with the VB_index. Otherwise, it means there is a mismatch.

In operation S730, it is determined whether the physical addresses are matched.

In operation S740, valid data located in the first source data block to the Nth source data block is determined.

In the example of the present disclosure, the valid data in the PTE table which is located in the first source data block to the Nth source data block is determined according to the aforementioned matching result. Meanwhile, the source data blocks corresponding to respective valid data may also be determined. Furthermore, the address mapping relationships LCA/PCAs stored in the PTE table for the determined valid data are read.

Operation S340B: write valid data located in the first source data block to the Nth source data block into the target data block.

In the example of the present disclosure, the address mapping relationships LCA/PCAs saved in the PTE table corresponding to the determined valid data is pushed to the retrieval queue. The related valid data is read by reading the address mapping relationship LCA/PCA for the valid data in the retrieval queue, and the related valid data is written into the preset target data block.

The garbage collection method provided by the example of the present disclosure, through matching the physical address of the valid data in the page table entry table corresponding to the merge bitmap with the index values of the first source data block to the Nth source data block, the valid data located in the first source data block to the Nth source data block in the page table entry table may be quickly determined, so as to write the related valid data into the target data block. Meanwhile, since the corresponding page table entry table is read based on the merge bitmap, the response latency caused by respectively source data blocks reading the page table entry table separately is avoided.

As mentioned above, the example of the present disclosure performs a parallel garbage collection process on multiple source data blocks, thereby reducing the response latency between respective source data blocks caused by repeatedly reading the PTE table, and improving the response efficiency of the overall garbage collection process. An example of the present disclosure may select multiple source data blocks from a plurality of or multiple data blocks for garbage collection processing. The selection process of the multiple source data blocks may be performed through the following various implementations.

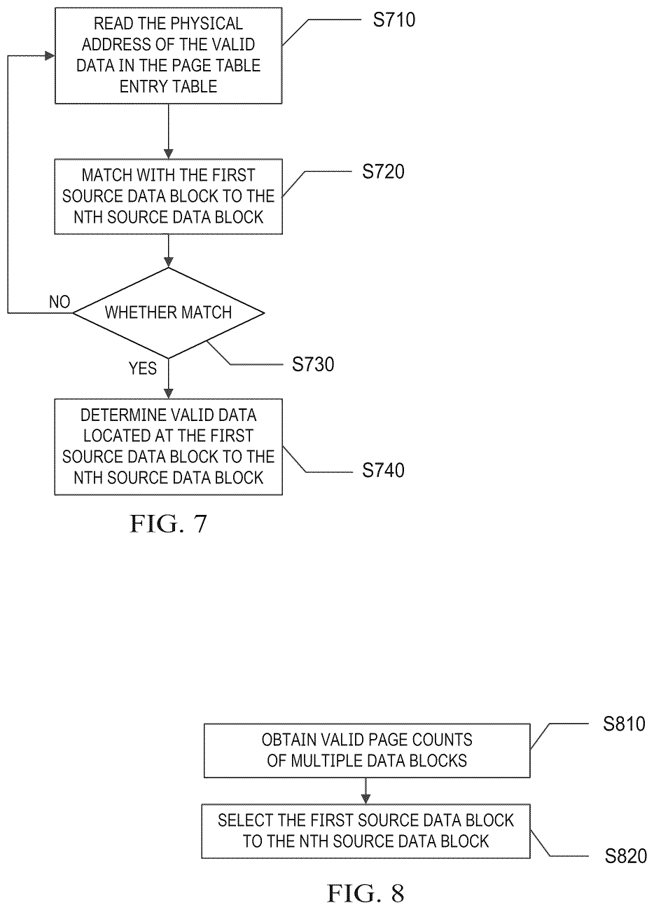

FIG. 8 is a schematic flowchart 1 of selecting a source data block according to an example of the present disclosure. As shown in the figure, the process of selecting a source data block may be applied to the memory controller shown in FIG. 2 and may include the following operations.

In operation S810, valid page counts of a plurality of or multiple data blocks are obtained.

In the example of the present disclosure, the plurality of or the multiple data blocks are data blocks to be selected for garbage collection. The plurality of or the multiple data blocks may be all data blocks in the memory device, or may be data blocks in a certain area to be performed for garbage collection. The Valid Page Count (VPC) is the quantity of valid data stored in each data block, where the valid data may be counted in unit of pages.

It should be noted that there are used data blocks (used VB) and unused data blocks in the memory device. The garbage collection operation is to perform garbage collection and reuse for the data blocks that have been written with data. The plurality of or the multiple data blocks in operation S810 may be further defined as used data blocks (used VB), and unused data blocks are not processed, thereby reducing processing complexity.

In operation S820, the first source data block to the Nth source data block are selected according to the valid page counts of the plurality of or the multiple data blocks.

In an example of the present disclosure, the smaller the count of valid pages in the data block is, the shorter time it takes to migrate the valid data on the data block to the target data block to complete garbage collection of the data block. Therefore, by selecting the first source data block to the Nth source data block through a reasonable selection strategy according to the valid page counts of a plurality of or multiple data blocks, the goal of improving the overall efficiency of the garbage collection process may be achieved.

It should be noted that, depending on the actual application scenario requirements, there may be many selection strategies for selecting multiple source data blocks based on the valid page counts of a plurality of or multiple data blocks. Any feasible selection strategy should be considered to be within the protection scope of this disclosure. Based on this, this disclosure schematically provides several feasible selection strategies.

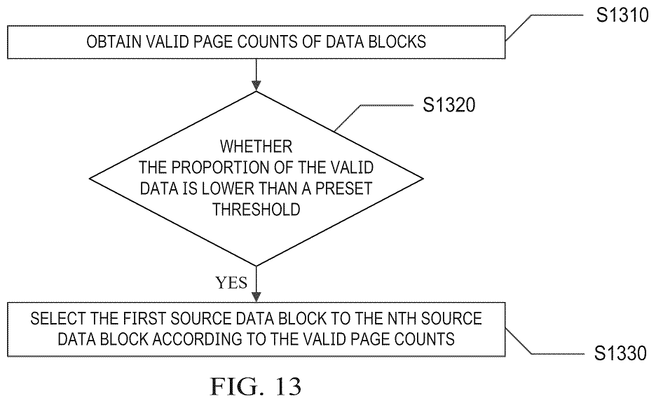

FIG. 13 is a schematic flowchart 3 of selecting a source data block according to an example of the present disclosure. In the example of the present disclosure, operation S1310 in the process of selecting the source data block in FIG. 13 corresponds to operation S810 in the process of selecting the source data block shown in FIG. 3, and will not be repeated here. Based on the foregoing process of selecting a source data block, the method may also include the following operations. This may be applied to the memory controller shown in FIG. 2.

In operation S1320, according to the valid page counts, it is determined whether proportions of valid data of respective data blocks in the plurality of or the multiple data blocks are lower than a preset threshold.

In the example of the present disclosure, the valid data proportion is the ratio of the valid page count in the data block to the total data storage space in the data block. A threshold is preset for the proportion of valid data, to conduct preliminary screening of data blocks.

In operation S1330, the first source data block to the Nth source data block are selected from the plurality of or the multiple data blocks with a proportion of valid data being lower than a preset threshold.

In the example of the present disclosure, due to the large number of data blocks in the memory device, if respective data blocks all participate in the selection of source data blocks, the efficiency of the selection decision may be affected. Therefore, the example of the present disclosure presets the threshold value to perform preliminary screening of data blocks. When the proportion of valid data in a data block is lower than the preset threshold, the data block participates in the selection of multiple source data blocks. In an illustrated example, the valid data proportion may be set to 60%. When the valid data proportion of the data block is higher than 60%, it will not participate in the selection of the source data block.

The selection strategy provided by the example of the present disclosure may be combined with other selection strategies, and may be used as a preliminary screening section for other selection strategies, or a complete selection strategy for source data block selection.

In the example of the present disclosure, the process of selecting a source data block may include the following operations.

In operation 1, according to the valid page counts, the plurality of or the multiple data blocks are ordered based on the valid page counts.

In an example of the present disclosure, the plurality of or the multiple data blocks are ordered according to the valid page counts of respective data blocks. In the example of the present disclosure, the plurality of or the multiple data blocks are ordered from smallest to largest based on the valid page counts.

In operation 2, according to the ordering of the data blocks, a preset number of the data blocks are selected as the first to Nth source data blocks.

In the example of the present disclosure, the number of source data blocks to be selected is preset, and the preset number of data blocks are selected from small to large based on the ordering of the aforementioned data blocks as the first source data block to the Nth source data block. As described above, the lower the valid page count in a data block is, the more efficiently garbage collection may be performed. Therefore, ordering and selecting multiple source data blocks based on valid page count may improve the overall efficiency of the garbage collection process.

In addition to selecting multiple source data blocks according to the selection strategy provided above, the example of the present disclosure may also combine the selection strategy described above with other selection strategies to select multiple source data blocks.

In the example of the present disclosure, in addition to using the valid page counts of a plurality of or multiple data blocks as a reference factor for selecting multiple source data blocks, the valid capacity of the target data block may also be used as a reference factor. Valid capacity refers to the remaining capacity in the data block available for storing data. The process of selecting a source data block may include the following operations.

Obtaining the valid page counts of a plurality of or multiple data blocks.

Obtaining the valid capacity of the target data block.

Selecting the first source data block to the Nth source data block according to the valid page counts of the plurality of or the multiple data blocks and the valid capacity of the target data block.

Based on the valid page counts of a plurality of or multiple data blocks and the valid capacity of the target data block, the current data storage situations of the data block and the target data block may be considered, so as to select the source data block better, to achieve a higher efficiency of the garbage collection processing.

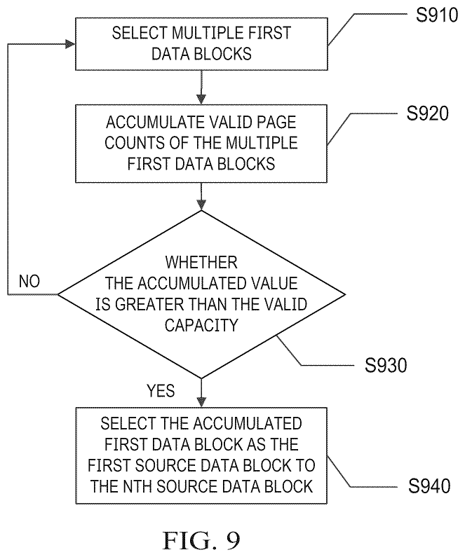

FIG. 9 is a schematic flowchart 2 of selecting a source data block according to an example of the present disclosure. As shown, the selecting the first source data block to the Nth source data block according to the valid page counts of the plurality of or the multiple data blocks and the valid capacity of the target data block may include the following operations. This may be applied to the memory controller shown in FIG. 2.

In operation S910, a plurality of or multiple data blocks are selected.

In the example of the present disclosure, a plurality of or multiple first data blocks are selected from the plurality of or the multiple data blocks. The plurality of or the multiple first data blocks may be selected based on preset rules, or may be randomly selected from a plurality of or multiple data blocks.

In an illustrated example, the selecting a plurality of or multiple data blocks means selecting a preset number of first data blocks. For example, the preset number is 12.

In an illustrated example, the plurality of or the multiple data blocks may be ordered based on the valid page count based on the foregoing. A preset number of first data blocks may then be selected from the plurality of or the multiple data blocks based on the ordering of the data blocks.

In operation S920, valid page counts of the plurality of or the multiple data blocks are accumulated.

In the example of the present disclosure, the valid page counts of the plurality of or the multiple data blocks selected in operation S910 are accumulated to obtain an accumulated value. The accumulated value means the storage space in the target data block required to migrate the valid data in the plurality of or the multiple data blocks.

In operation S930, it is determined whether the accumulated value for the valid page counts is greater than the valid capacity.

In the example of the present disclosure, it is determined whether the accumulated value is greater than the valid capacity of the aforementioned target data block. If the accumulated value is not greater than the valid capacity of the target data block, it means that the valid data in the first data blocks being accumulated may be accommodated in the target data block.

In an illustrated example, when the accumulated value is not greater than the valid capacity of the target data block, operation S910 may be returned to further select more first data blocks to fully utilize the valid capacity of the target data block as much as possible. On the contrary, when the accumulated value is greater than the valid capacity of the target data block, it means that the valid capacity of the target data block has been saturated, and there is no need to further select the first data block.

In operation S940, in response to the accumulated value for the valid page counts being no greater than the valid capacity of the target data block, the first data blocks being accumulated is selected as the first source data block to the Nth source data block.

In the example of the present disclosure, if the accumulated value is not greater than the valid capacity of the target data block, it means that the valid data in the first data blocks being accumulated may be accommodated in the target data block. Therefore, the first data blocks being accumulated are selected to be the first source data block to the Nth source data block, that is, it is determined as the source data blocks which participate in garbage collection.

In the example of the present disclosure, the selected first data block is continuously accumulated through the operations S910 to S930 described above, and as long as the accumulated value is not greater than the valid capacity of the target data block, it means that the valid data in the first data blocks being accumulated may be accommodated in the target data block. Until when the accumulated value is greater than the valid capacity of the target data block, it means that the valid capacity of the target data block has been saturated, and the accumulation process described above is stopped. Before the accumulated value is greater than the valid capacity, the first data blocks being accumulated is selected to be the first source data block to Nth source data block.

The garbage collection method provided by the example of the present disclosure provides a variety of implementations for a source data block selection strategy. The related selection strategy may be based on parameters such as the valid page count of the data block, the valid capacity of the target data block, the preset number, the valid data proportion of the data block, etc., and may be flexibly combined to form an adapted source data block selection strategy according to different requirements of actual application scenarios. By selecting the first source data block to the Nth source data block through a reasonable selection strategy, the goal of improving the overall efficiency of the garbage collection process may be achieved.

Due to physical characteristics of a memory device, the memory device is limited to a certain number of erase and write times, and frequent write operations will accelerate the aging of the memory device. Filling up the storage space of the data block may reduce the number of data write times, thereby extending the service life of the data block. Therefore, for a memory device, it is expected that the storage space of the data block will be filled as much as possible to reduce the number of times it writes data. Based on this, the garbage collection method in the example of the present disclosure further includes the following implementations so that the target data block is fully written.

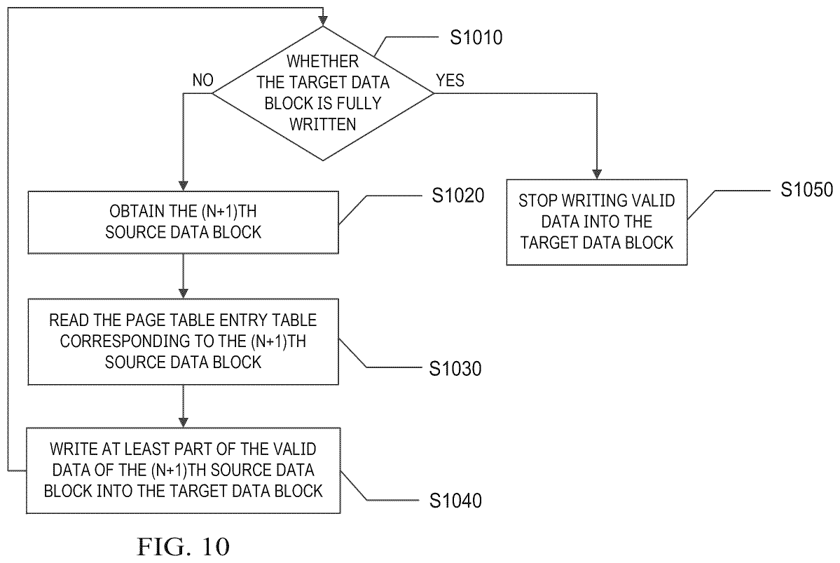

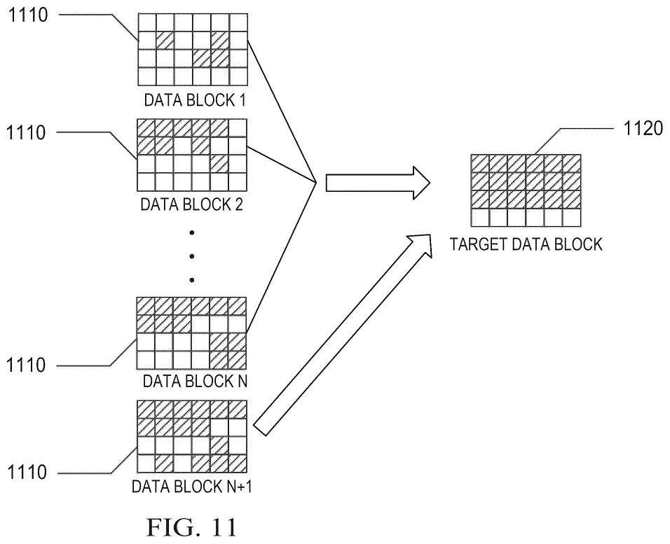

FIG. 10 is a schematic flowchart 1 of valid data migration according to an example of the present disclosure. FIG. 11 is a schematic diagram of valid data migration process according to an example of the present disclosure. As shown in the figure, the process of the valid data migration may be applied to the memory controller shown in FIG. 2 and may include the following operations. In operation S1010, it is determined whether the target data block is fully written.

In the example of the present disclosure, after writing valid data from the first source data block (e.g., data block 1 1110 in FIG. 11) to the Nth source data block (e.g., data block N 1110 in FIG. 11) into the target data block (e.g., target data block 1120 in FIG. 11) as described above, it is determined, by the garbage collection method, whether the target data block has been fully written. If the target data block is not fully written, the following operation S1020 is performed. If the target data block is fully written, the following operation S1050 is performed.

In operation S1020, in response to the target data block being not fully written, the (N+1)th source data block (e.g., data block N+1 1110 in FIG. 11) is obtained.

In an example of the present disclosure, when the target data block is not fully written, in order to fully utilize the storage space of the target data block, the target data block is fully written as much as possible, and the (N+1)th source data block is further obtained. The selection strategy of the (N+1)th source data block may be based on any of the aforementioned source data block selection strategies, which will not be repeated here.

In operation S1030, the corresponding page table entry table is read according to the (N+1)th bitmap corresponding to the (N+1)th source data block.

In the example of the present disclosure, the corresponding PTE table is read according to the (N+1)th bitmap corresponding to the (N+1)th source data block. The related process has been described in detail in the aforementioned operation S330 and will not be repeated here.

In operation S1040, at least part of the valid data corresponding to the (N+1)th source data block in the page table entry table is written into the target data block.

In the example of the present disclosure, at least part of the valid data corresponding to the (N+1)th source data block in the PTE table is written into the target data block. The related process has been described in detail in the aforementioned operation S340 and will not be repeated here.

It should be noted that during the process of migrating the valid data in the N+1 source data block, the target data block may be fully written. Therefore, the migrating operation may only be performed on at least part of the valid data in the (N+1)th source data block. After the target data block is fully written, migrating operation may not be performed on the remaining valid data. The migrating order of the valid data in the (N+1)th source data block may be randomly selected or migrated according to preset rules, which is not particularly limited here.

In operation S1050, in response to the target data block being fully written, writing of valid data into the target data block is stopped.

In the example of the present disclosure, when the target data block is fully written, writing of valid data into the target data block is stopped.

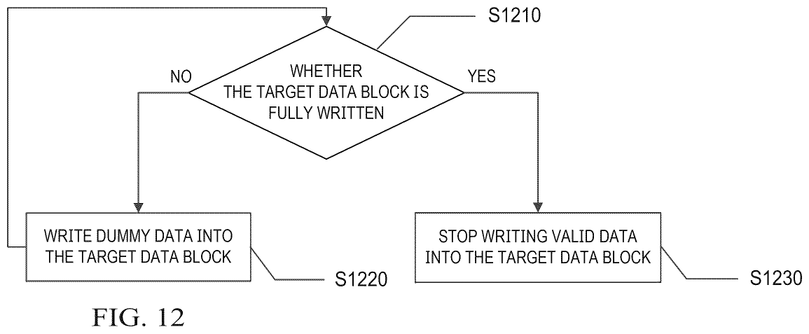

FIG. 12 is a schematic flowchart 2 of valid data migration according to an example of the present disclosure. As shown in the figure, the process of the valid data migration may be applied to the memory controller shown in FIG. 2 and may include the following operations.

In operation S1210, it is determined whether the target data block is fully written.

In the example of the present disclosure, after writing valid data from the first source data block to the Nth source data block into the target data block as described above, it is determined, by the garbage collection method, whether the target data block has been fully written. If the target data block is not fully written, the following operation S1220 is performed. If the target data block is fully written, the following operation S1230 is performed.

In operation S1220, in response to the target data block not being fully written, dummy data is written into the target data block.

In an example of the present disclosure, when the target data block is not fully written, in order to fully utilize the storage space of the target data block, the target data block is fully written as much as possible, and dummy data is further written into the target data block. Dummy data is a data structure used to simulate the usage of actual storage space. By writing the virtual data into the remaining storage space in the target data block, the target data block may be fully written and the number of write times to the target data block may be reduced.

After writing the dummy data into the target data block, return to operation S1210 to determine whether the target data block is fully written. If the target data block is not fully written, continue writing dummy data to the target data block until the target data block is fully written.

In operation S1030, in response to the target data block being fully written, writing of valid data into the target data block is stopped.

In the example of the present disclosure, when the target data block is fully written, writing of valid data into the target data block is stopped.

The garbage collection method provided by the example of the present disclosure provides multiple ways to fully write the target data block. By fully writing the target data block, the number of times data is written to the target data block may be reduced, thereby extending the service life of the data block.

Based on the same inventive concept, examples of the present disclosure also provide a memory system, as described in the following examples. Since the problem-solving principle of this memory system example is similar to that of the garbage collection method example described above, thus the implementation of this memory system example may be referred to the implementation of the method example described above, which will not be repeated here.

FIG. 1A is a schematic diagram of an illustrated system with a memory system according to an example of the present disclosure. The memory system 102 may be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having memory device therein. Referring to FIG. 1A, the memory system 102 includes: one or more memory devices 104 as in the example described above; and a memory controller 106 coupled to the memory device 104, wherein the memory controller 106 is configured to:
obtain the first bitmap corresponding to the first source data block to the Nth bitmap corresponding to the Nth source data block; N is an integer greater than or equal to 2; the bitmap containing an identifier directing to the page table entry table for the corresponding data block;
obtain a merge bitmap based on the first bitmap to the Nth bitmap;
read the page table entry table according to the merge bitmap;
write valid data corresponding to the first source data block to the Nth source data block in the page table entry table into a target data block.

In an example of the present disclosure, the memory controller 106 is further configured to: search for valid data at physical addresses in the page table entry table which are located in the first source data block to the Nth source data block; write valid data at physical addresses in the page table entry table which are located in the first source data block to the Nth source data block into the target data block.

In an example of the present disclosure, the memory controller 106 is further configured to: in response to the valid data being written into the target data block, update a logical address to physical address mapping table; release the first source data block to the Nth source data block.

In an example of the present disclosure, the memory controller 106 is further configured to: perform an OR operation on bits corresponding to the first bitmap to the Nth bitmap to obtain the merge bitmap.

In an example of the present disclosure, the memory controller 106 is further configured to: match the data block bits of the physical addresses corresponding to the valid data in the page table entry table with the data block index values of the first source data block to the Nth source data block respectively, to determine valid data located in the first source data block to the Nth source data block.

In an example of the present disclosure, the memory controller 106 is further configured to: obtain the valid page counts of a plurality of or multiple data blocks; select the first source data block to the Nth source data block according to the valid page counts of the plurality of or the multiple data blocks.

In an example of the present disclosure, the memory controller 106 is further configured to: obtain the valid capacity of the target data block; select the first source data block to the Nth source data block according to the valid page counts of the plurality of or the multiple data blocks and the valid capacity of the target data block.

In an example of the present disclosure, the memory controller 106 is further configured to: select a plurality of or multiple data blocks from small to large according to the valid page counts of the plurality of or the multiple data blocks; according to the valid page counts of the plurality of or the multiple data blocks from small to large, select the N first data blocks as the first source data block to the Nth source data block, wherein the a accumulated value of the valid page counts of the N first data blocks is not greater than the valid capacity of the target data block.

In an example of the present disclosure, the memory controller 106 is further configured to: the selecting a plurality of or multiple data blocks including selecting a preset number of first data blocks.

In an example of the present disclosure, the memory controller 106 is further configured to: in response to the target data block being not fully written with data, obtain the (N+1)th source data block; according to the (N+1)th bitmap corresponding to the (N+1)th source data block, read the corresponding page table entry table; write at least part of the valid data corresponding to the (N+1)th source data block in the page table entry table into the target data block until the target data block is fully written.

In an example of the present disclosure, the memory controller 106 is further configured to: in response to the target data block being not fully written, write dummy data into the target data block until the target data block is fully written.

In an example of the present disclosure, the memory controller 106 is further configured to: determine proportions of valid data of respective data blocks in the plurality of or the multiple data blocks according to the valid page counts; select the first source data block to the Nth source data block from the plurality of or the multiple data blocks with a proportion of valid data being lower than a preset threshold.

Based on the same inventive concept, examples of the present disclosure also provide a memory controller, as described in the following examples. Since the problem-solving principle of this memory controller example is similar to that of the garbage collection method example described above, thus the implementation of this memory controller example may be referred to the implementation of the method example described above, which will not be repeated here.

FIG. 2 is a schematic diagram of an illustrated memory controller with a memory system according to an example of the present disclosure. Referring to FIG. 2, the memory controller 106 includes: a controller memory 213 configured to store control instructions; and a controller processor 210 coupled to the controller memory 213 and configured to execute the control instructions to perform a process, the process includes:
obtaining the first bitmap corresponding to the first source data block to the Nth bitmap corresponding to the Nth source data block; N is an integer greater than or equal to 2; the bitmap containing an identifier directing to the page table entry table for the corresponding data block;
obtaining a merge bitmap based on the first bitmap to the Nth bitmap;
reading the page table entry table according to the merge bitmap;
writing valid data corresponding to the first source data block to the Nth source data block in the page table entry table into a target data block.

In an example of the present disclosure, the process further includes: searching for valid data at physical addresses in the page table entry table which are located in the first source data block to the Nth source data block; writing valid data located in the first source data block to the Nth source data block into the target data block.

In an example of the present disclosure, the process further includes: according to the valid data being written into the target data block, updating a logical address to physical address mapping table; releasing the first source data block to the Nth source data block.

In an example of the present disclosure, the process further includes: performing an OR operation on bits corresponding to the first bitmap to the Nth bitmap to obtain the merge bitmap.

In an example of the present disclosure, the process further includes: matching the data block bits of the physical addresses corresponding to the valid data in the page table entry table with the data block index values of the first source data block to the Nth source data block respectively, to determine valid data located in the first source data block to the Nth source data block.

In an example of the present disclosure, the process further includes: obtaining the valid page counts of a plurality of or multiple data blocks; selecting the first source data block to the Nth source data block according to the valid page counts of the plurality of or the multiple data blocks.

In an example of the present disclosure, the process further includes: obtaining the valid capacity of the target data block; selecting the first source data block to the Nth source data block according to the valid page counts of the plurality of or the multiple data blocks and the valid capacity of the target data block.

In an example of the present disclosure, the process further includes: selecting a plurality of or multiple data blocks; accumulating the valid page counts of the plurality of or the multiple data blocks; in response to the accumulated value for the valid page counts being no greater than the valid capacity of the target data block, selecting the first data blocks being accumulated as the first source data block to the Nth source data block.

In an example of the present disclosure, the process further includes: the selecting a plurality of or multiple data blocks comprising selecting a preset number of first data blocks.

In an example of the present disclosure, the process further includes: in response to the target data block being not fully written with data, obtaining the (N+1)th source data block; according to the (N+1)th bitmap corresponding to the (N+1)th source data block, reading the corresponding page table entry table; writing at least part of the valid data corresponding to the (N+1)th source data block in the page table entry table into the target data block until the target data block is fully written.

In an example of the present disclosure, the process further includes: in response to the target data block being not fully written, writing dummy data into the target data block until the target data block is fully written.

In an example of the present disclosure, the process further includes: determining proportions of valid data of respective data blocks in the plurality of or the multiple data blocks according to the valid page counts; selecting the first source data block to the Nth source data block from the plurality of or the multiple data blocks with a proportion of valid data being lower than a preset threshold.

In an illustrated example, a non-transitory, computer-readable storage medium including instructions is also provided, e.g., a controller memory including instructions, and the instructions may be executed by a controller processor of the memory controller to achieve the method described above. Alternatively, the computer-readable storage medium may be ROM, random access memory (RAM), CD-ROM, magnetic tape, floppy disk, optical data memory device, etc.

In an illustrated example, a computer program product is also provided, which includes computer programs/instructions, and the computer programs/instructions are executed by a processor to implement method in the example described above.

It should be understood that reference throughout the description to “some examples” means that a particular feature, structure or characteristic related to the example is included in at least one example of the present disclosure. Thus, appearances of “in some examples” or “in other examples” in various places throughout the description are not necessarily referring to a same example. Furthermore, these particular features, structures or characteristics may be combined in any appropriate manner in one or more examples. It should be understood that in various examples of the present disclosure, sequence numbers of the processes described above do not mean the execution order, and the execution order of each process should be determined by its function and internal logic, and should not constitute any limitation to implementation process of examples of the present disclosure. The serial numbers of examples of the present disclosure described above are for the purpose of description only, and do not represent the advantages and disadvantages of the examples.

It should be noted that, in this description, the terms “including”, “containing” or any other variations thereof are intended to cover a non-exclusive inclusion, such that a process, method, article or device that includes a series of elements includes not only those elements but also other elements not expressly listed or that are inherent to the process, method, article or device. Without further limitation, an element defined by the statement “including a . . . ” does not exclude the presence of additional identical elements in a process, method, article, or device that includes that element.

In the several examples provided in the present disclosure, it should be understood that the disclosed devices and methods may be implemented in other ways. The device examples described above are only illustrative, e.g., the division of the elements is only a logical function division, and in actual implementation, there may be other division methods, such as multiple elements or components may be combined, or may be integrated into another system, or some features may be ignored, or not implemented. In addition, the coupling, or direct coupling, or communication connection between the components shown or discussed may be indirect coupling or communication connection of devices or elements through some interfaces, and may be electrical, mechanical or in other forms.

The elements described above as separate parts may or may not be physically separated, and the parts displayed as elements may or may not be physical elements, which may be located in one place or distributed to multiple network elements; and portions or all of these elements may be selected according to actual needs to achieve the purpose of the solution of this example.

In addition, each functional unit in each example of the present disclosure may be integrated into one processing unit, or each unit may be used as a single unit, or two or more units may be integrated into one unit; the integrated units described above may be implemented in the form of hardware, or in the form of hardware plus software functional units.

The above is only an implementation of the present disclosure, but the claimed scope of the present disclosure is not limited thereto, and changes or substitutions within the technical scope disclosed in the present disclosure that may be easily conceived by those skilled in the art shall fall within the claimed scope of the present disclosure. Therefore, the claimed scope of the present disclosure should be determined by the claimed scope of the claims.

What is claimed is:

1. A memory system, comprising:
a memory device; and
a memory controller coupled to the memory device, wherein the memory controller is configured to:
obtain a first bitmap corresponding to a first source data block to a Nth bitmap corresponding to a Nth source data block, N being an integer greater than or equal to 2, a bitmap containing an identifier directing to a page table entry table for a corresponding data block;
obtain a merge bitmap based on the first bitmap to the Nth bitmap;
read the page table entry table according to the merge bitmap; and
write valid data corresponding to the first source data block to the Nth source data block in the page table entry table into a target data block.

2. The memory system of claim 1, wherein the memory controller is further configured to:
search for valid data at physical addresses in the page table entry table which are located in the first source data block to the Nth source data block; and
write valid data at physical addresses in the page table entry table which are located in the first source data block to the Nth source data block into the target data block.

3. The memory system of claim 1, wherein the memory controller is further configured to:
in response to the valid data being written into the target data block, update a logical address to physical address mapping table; and
release the first source data block to the Nth source data block.

4. The memory system of claim 1, wherein the memory controller is further configured to:
perform an OR operation on bits corresponding to the first bitmap to the Nth bitmap to obtain the merge bitmap.

5. The memory system of claim 2, wherein the memory controller is further configured to:
match data block bits of the physical addresses corresponding to the valid data in the page table entry table with data block index values of the first source data block to the Nth source data block respectively, to determine valid data located in the first source data block to the Nth source data block.

6. The memory system of claim 1, wherein the memory controller is further configured to:
obtain valid page counts of multiple data blocks; and
select the first source data block to the Nth source data block according to the valid page counts of the multiple data blocks.

7. The memory system of claim 6, wherein the memory controller is further configured to:
obtain valid capacity of the target data block; and
select the first source data block to the Nth source data block according to the valid page counts of the multiple data blocks and the valid capacity of the target data block.

8. The memory system of claim 7, wherein the memory controller is further configured to:
select multiple first data blocks;
accumulate the valid page counts of the multiple first data blocks; and
in response to an accumulated value for the valid page counts being no greater than the valid capacity of the target data block, select the first data blocks being accumulated as the first source data block to the Nth source data block.

9. The memory system of claim 8, wherein the memory controller is further configured to:
the selecting multiple first data blocks including selecting a preset number of first data blocks.

10. The memory system of claim 1, wherein the memory controller is further configured to:
in response to the target data block being not fully written, obtain a (N+1)th source data block;
read a corresponding page table entry table according to a (N+1)th bitmap corresponding to the (N+1)th source data block; and
write at least part of the valid data corresponding to the (N+1)th source data block in the page table entry table into the target data block until the target data block is fully written.

11. The memory system of claim 1, wherein the memory controller is further configured to:
in response to the target data block being not fully written, write dummy data into the target data block until the target data block is fully written.

12. The memory system of claim 6, wherein the memory controller is further configured to:
determine proportions of valid data of respective data blocks in the multiple data blocks according to the valid page counts; and
select the first source data block to the Nth source data block from the multiple data blocks with a proportion of valid data being lower than a preset threshold.

13. A method of garbage collection, comprising:
obtaining a first bitmap corresponding to a first source data block to a Nth bitmap corresponding to a Nth source data block, N being an integer greater than or equal to 2, and a bitmap containing an identifier directing to a page table entry table for a corresponding data block;
obtaining a merge bitmap based on the first bitmap to the Nth bitmap;
reading the page table entry table according to the merge bitmap; and
writing valid data corresponding to the first source data block to the Nth source data block in the page table entry table into a target data block.

14. The method of claim 13, wherein the writing valid data corresponding to the first source data block to the Nth source data block in the page table entry table into a target data block includes:
searching for valid data at physical addresses in the page table entry table which are located in the first source data block to the Nth source data block; and
writing valid data located in the first source data block to the Nth source data block into the target data block.

15. The method of claim 13, further including:
updating a logical address to physical address mapping table according to the valid data being written into the target data block; and
releasing the first source data block to the Nth source data block.

16. The method of claim 13, wherein the obtaining a merge bitmap based on the first bitmap to the Nth bitmap includes:
performing an OR operation on bits corresponding to the first bitmap to the Nth bitmap to obtain the merge bitmap.

17. The method of claim 14, wherein the searching for valid data at physical addresses in the page table entry table which are located in the first source data block to the Nth source data block includes:
matching data block bits of the physical addresses corresponding to the valid data in the page table entry table with data block index values of the first source data block to the Nth source data block respectively, to determine valid data located in the first source data block to the Nth source data block.

18. The method of claim 13, further including:
obtaining valid page counts of multiple data blocks; and
selecting the first source data block to the Nth source data block according to the valid page counts of the multiple data blocks.

19. The method of claim 13, further including:
in response to the target data block being not fully written, writing dummy data into the target data block until the target data block is fully written.

20. A non-transitory, computer-readable storage medium, wherein when control instructions in the computer-readable storage medium are executed by a controller processor, the controller processor is enabled to perform a garbage collection method, comprising:
obtaining a first bitmap corresponding to a first source data block to a Nth bitmap corresponding to a Nth source data block, N being an integer greater than or equal to 2, and a bitmap containing an identifier directing to a page table entry table for a corresponding data block;
obtaining a merge bitmap based on the first bitmap to the Nth bitmap;
reading the page table entry table according to the merge bitmap; and
writing valid data corresponding to the first source data block to the Nth source data block in the page table entry table into a target data block.
